(19) United States
(12) Patent Application Publication
(10) Pub. No.: US 2025/0337827 A1
(43) Pub. Date: Oct. 30, 2025

(54) Foldable Stand

(71) Applicant: Anker Innovations Technology Co., Ltd., Changsha (CN)

(72) Inventors: Xianjie Tang, Shenzhen (CN); Songya Chen, Shenzhen (CN)

(21) Appl. No.: 19/185,580

(22) Filed: Apr. 22, 2025

(30) Foreign Application Priority Data
Apr. 26, 2024 (CN) 202420901668.2

(51) Int. Cl. H04M 1/02; F16M 11/20; F16M 11/38

(52) U.S. Cl. CPC H04M 1/0279; F16M 11/2021; F16M 11/38

(57) ABSTRACT

Various features herein describe a foldable stand. The foldable stand may be used for supporting or holding a mobile device such as mobile phone. The foldable stand comprises a first plate, a second plate, a supporting plate, and a transmission device. A first end of the second plate is rotatably connected to the first plate, which can support a mobile device. The supporting plate and the transmission device can be both provided on the second plate. In response to rotation of the first plate relative to the second plate, the transmission device is configured to drive the supporting plate to slide relative to the second plate.

### CROSS-REFERENCE OF RELATED APPLICATION

The present application claims priority to Chinese Patent Application No. 202420901668.2, filed on Apr. 26, 2024, which is herein incorporated by reference by its entirety.

### FIELD

The present disclosure relates to the technical field of folding stands, in particular to a foldable phone stand.

### BACKGROUND

With the rapid development of society, mobile devices have become more popular because mobile devices are portable and can meet people's needs for obtaining information and interacting on the Internet anytime and anywhere. In order to better use the mobile devices, people have designed some complementary components to improve convenience of using the mobile devices, including a folding stand (e.g., a foldable stand).

A folding stand can adjust an angle at which a mobile device is placed to free the user's hands and meet viewing angle requirements of the user for the mobile device. However, the present folding stand has certain disadvantages during use. When the present folding stand is in use, the user may adjust the angle at which the mobile device is placed too much, but a support force provided for the mobile device by the folding stand may be insufficient, causing the folding stand and the mobile device to overturn.

### SUMMARY

The present disclosure provides a foldable stand to solve the above technical problem. The foldable stand may be used for supporting or holding a mobile device such as mobile phone. The foldable stand comprises a first plate, a second plate, a supporting plate, and a transmission device. A first end of the second plate is rotatably connected to the first plate, which can support a mobile device. The supporting plate and the transmission device can be both provided on the second plate. In response to rotation of the first plate relative to the second plate, the transmission device is configured to drive the supporting plate to slide relative to the second plate. In an example, a first surface of the second plate comprises a first groove provided at an end where the second plate is connected to the first plate, and the supporting plate and the transmission device are both provided in the first groove. The first groove is configured to limit movement of the supporting plate along a direction perpendicular to the surface of the second plate. While the first plate is rotated relative to the second plate to increase an angle between the first plate and the second plate, the supporting plate is configured to slide relative to the second plate along a direction away from an end of the second plate, and at least part of the supporting plate is configured to slide out of the first groove to support the first plate.

In an example, the transmission device comprises a gear and a swing block both provided in the first groove, and gear teeth of the gear are configured to abut against first gear teeth of the swing block to drive the swing block to swing, in which the first gear teeth are provided at a first end of the swing block. A second end of the swing block is configured to abut against the supporting plate. The swing block is configured to drive the supporting plate to slide through the second end of the swing block, and the first end and the second end of the swing block are opposite ends of the swing block.

In an example, the second end of the swing block comprises second gear teeth, a side of the supporting slide plate close to the swing block comprises third gear teeth, the third gear teeth abut against the second gear teeth, and the swing block is configured to drive the supporting slide plate to slide based on engagement of the second gear teeth and the third gear teeth.

In an example, an angle between two adjacent gear teeth on the gear is greater than an angle between two adjacent gear teeth in the first gear teeth.

In an example, the first surface of the second plate further comprises a second groove and a third groove both provided at the bottom of the first groove. The gear is provided in the second groove, and the swing block is provided in the third groove. The second groove is a circular groove, and a size of the second groove is greater than or equal to a size of the gear.

In an example, the first plate comprises a rotating rod, the second plate comprises a fixing member, and the first plate and the second plate are rotatably connected through joining of the rotating rod and the fixing member. The rotating rod is provided with a guide groove extending on a body of the rotating rod in a direction away from an end surface of the rotating rod. The second groove is spaced apart from the rotating rod, and part of the gear teeth of the gear in the second groove are provided in the guide groove. When the rotating rod is rotated to realize the rotation of the first plate relative to the second plate, the guide groove is configured to drive the gear to rotate, then the gear is configured to drive the swing block to swing, and the swing block is configured to drive the supporting plate to slide.

In an example, the first surface of the second plate comprises two gear grooves, each of which comprises the communicating second groove and third groove, and the two gear grooves are provided at the bottom of the first groove and symmetrically in the first groove. The foldable stand comprises two transmission devices respectively provided in the gear grooves.

In an example, a thickness of a first end of the supporting plate is less than a thickness of a second end of the supporting plate, in which the first end of the supporting slide plate is provided close to the second end of the second plate, and the second end of the supporting plate is provided away from the second end of the second plate.

In order to solve the above technical problem, the present disclosure further provides a system comprising the foldable stand as described above and a mobile device. The mobile device is provided on a first plate of the foldable stand, and the first plate can be rotated relative to a second plate of the foldable stand to change an angle at which the mobile device is placed. While the first plate is rotated relative to the second plate, a supporting plate of the foldable stand is configured to slide relative to the second plate to change a supporting area for the mobile device.

Beneficial effects of the disclosure are: Different from the related art, the foldable stand of the present disclosure can be applied to a mobile device to reliably change the angle at which the mobile device is placed. The foldable stand comprises a first plate, a second plate, a supporting plate, and a transmission device. A first end of the second plate is rotatably connected to the first plate, which can support a mobile device. The supporting plate and the transmission device can be both provided on the second plate. In response to rotation of the first plate relative to the second plate, the transmission device is configured to drive the supporting plate to slide relative to the second plate In this way, the supporting area for the mobile device is increased and the stability of supporting the first plate is increased, thereby avoiding the situation that the foldable stand and the mobile device overturn due to the insufficient support force of the second plate for the first plate when the angle between the first plate and the second plate is large, improving the stability and practicality of the foldable, and improving the user experience of the foldable stand.

### BRIEF DESCRIPTION OF DRAWINGS

In order to more clearly illustrate technical solutions in examples of the present disclosure, drawings that need to be used in description of the examples are briefly introduced below, and it will be apparent in to those of ordinary skill in the art that the drawings in the following description are only some examples of the disclosure, and other drawings can be obtained in accordance with these drawings without inventive work.

FIG. 1 is a schematic structural diagram of a folding stand according to an example of the present disclosure;

FIG. 2 is a schematic structural diagram of a folding stand according to an example of the present disclosure;

FIG. 3 is a schematic structural diagram of a folding stand according to an example of the present disclosure;

FIG. 4 is a schematic diagram of a partial structure of the folding stand shown in FIG. 3;

FIG. 5 is a schematic structural diagram of a supporting slide plate according to an example of the present disclosure; and

FIG. 6 is a schematic structural diagram of an upper shell component according to an example of the present disclosure.

Reference Numerals: folding stand 1; upper shell component 11; rotating rod 111; guide groove 1111; lower shell component 12; first groove 121; second groove 122; third groove 123; fixing member 124; supporting slide plate 13; third gear teeth 131; transmission component 14; gear 141; swing block 142; first gear teeth 1421; second gear teeth 1422; mobile device 2.

### DETAILED DESCRIPTION

Solutions of examples of the present disclosure are described in detail hereinafter with reference to the accompanying drawings. In the following description, for the purpose of description rather than limitation, specific details such as specific system structures, interfaces, and technologies are provided to facilitate a thorough understanding of the present disclosure.

A particular feature, structure, or characteristic described with reference to an example can be included in at least one example of the present disclosure. Examples appearing in various places in the description not necessarily refer to the same example, and are not independent or alternative examples mutually exclusive of other examples. It is understood explicitly and implicitly by those skilled in the art that the examples described herein may be combined with other examples.

The term “and/or” in the disclosure only describes an association relationship between associated objects and indicates that there may be three relationships. For example, A and/or B may mean: A alone, both A and B, and B alone. In addition, the character “/” herein generally indicates that the former and latter associated objects are in an “or” relationship. Furthermore, “plurality” herein means two or more than two. In addition, the term “at least one” herein means any one of a plurality or any combination of at least two of a plurality, for example, including at least one of A, B and C may mean including any one or more elements selected from the group consisting of A, B and C. In addition, the terms “first”, “second” and “third” herein are used for a descriptive purpose only and are not to be construed as indicating or implying the relative importance or implicitly indicating the number of indicated technical features.

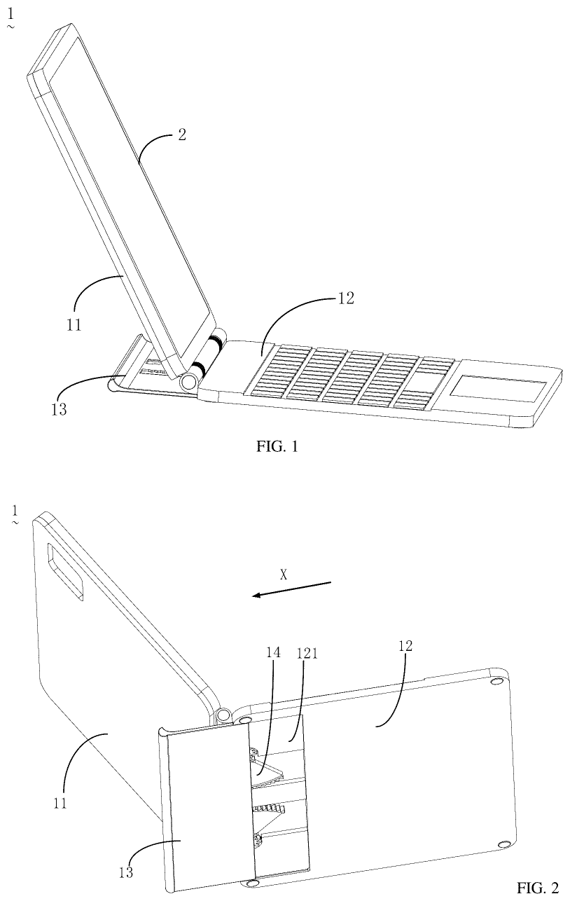

Referring to FIG. 1 and FIG. 2, FIG. 1 is a schematic structural diagram of a folding stand according to an example of the present disclosure; FIG. 2 is a schematic structural diagram of a folding stand according to an example of the present disclosure. A folding stand 1 (e.g., foldable stand) provided in an example of the present disclosure is applied to a mobile device 2 to change an angle at which the mobile device 2 is placed. The mobile device 2 may be an electronic device such as a mobile phone, a game console, or a tablet computer.

The folding stand 1 includes an upper shell component 11 (e.g., an upper support, an upper plate), a lower shell component 12 (e.g., a lower support, a lower plate), a supporting slide plate 13 and a transmission component 14.

The upper shell component 11 is configured to place (e.g., support, hold) the mobile device 2. In an example, the upper shell component 11 includes a magnetic member, and the mobile device 2 can be fixed on the upper shell component 11 by magnetic attraction, which simplifies difficulty of a user in fixing the mobile device 2 on the upper shell component 11, facilitates a user to load and unload the mobile device 2, and improves convenience of using the folding stand 1.

A first end of the lower shell component 12 is rotatably connected to the upper shell component 11, and the upper shell component 11 can be rotated relative to the lower shell component 12. Since the mobile device 2 is provided on the upper shell component 11, the upper shell component 11 can drive the mobile device 2 to rotate relative to the lower shell component 12, so as to change the angle at which the mobile device 2 is placed. The lower shell component 12 is configured to support the upper shell component 11.

Furthermore, the supporting slide plate 13 and the transmission component 14 are provided on the lower shell component 12, and are both provided close to the connection between the upper shell component 11 and the lower shell component 12. For example, the supporting slide plate 13 and the transmission component 14 are provided close to the first end of the lower shell component 12, and the transmission component 14 abuts against the supporting slide plate 13. In an example, as shown in FIG. 1, the lower shell component 12 may be provided with a keyboard. When the mobile device 2 is placed on the upper shell component 11, the keyboard may be connected to the mobile device 2, and thus the user may operate the mobile device 2 through the keyboard, further improving the convenience of the folding stand 1.

A side of the lower shell component 12 with the keyboard is a front side, and the supporting slide plate 13 and the transmission component 14 can be provided on a back side of the lower shell component 12. When the folding stand 1 is placed on a desktop, the lower shell component 12 can cover part of the supporting slide plate 13 and the transmission component 14 to improve aesthetic of the folding stand 1.

If the folding stand only has the lower shell component 12 to support the upper shell component 11, when the upper shell component 11 is rotated to a point where the angle between the upper shell component 11 and the lower shell component 12 is greater than a preset angle (e.g., 90°), a projection of the center of gravity of the upper shell component 11 is not within the range of the lower shell component 12. Thus, the lower shell component 12 may be unable to provide sufficient support force for the upper shell component 11, which can cause the folding stand 1 together with the mobile device 2 to overturn. Safety of the folding stand 1 and the mobile device 2 cannot be guaranteed.

In this example, the folding stand 1 further includes a supporting slide plate 13. Specifically, while the upper shell component 11 is rotated relative to the lower shell component 12 to increase an angle between the upper shell component 11 and the lower shell component 12, the transmission component 14 moves to drive the supporting slide plate 13 to move (e.g., slide) relative to the lower shell component 12 in a direction away from a second end of the lower shell component 12, so as to increase a supporting area for the upper shell component 11 and increase stability of supporting the upper shell component 11.

As shown in FIG. 1, when the angle between the upper shell component 11 and the lower shell component 12 is greater than a preset threshold (e.g., 90°), since part of the supporting slide plate 13 slides out of the range of the lower shell component 12, an area supporting the upper shell component 11 at this time is the area of the lower shell component 12 plus an area of the supporting slide plate 13 sliding out of the lower shell component 12, thereby increasing the area supporting the upper shell component 11. As the upper shell component 11 is rotated relative to the lower shell component 12, the center of gravity of the upper shell component 11 moves away from the second end of the lower shell component 12. When the projection of the center of gravity of the upper shell component 11 is not within the range of the lower shell component 12 (e.g., the angle between the upper shell component 11 and the lower shell component 12 is greater than 90°), as the lower shell component 12 continues to be rotated relative to the lower shell component 12, the supporting slide plate 13 may slide away from the second end of the lower shell component 12. In other words, the supporting slide plate 13 may move following the center of gravity of the upper shell component 11 to support the upper shell component 11, thereby preventing the folding stand 1 from overturning due to an excessive rotation angle of the upper shell component 11 and improving the stability of the folding stand 1.

Besides, the support of the supporting slide plate 13 on the upper shell component 11 allows the upper shell component 11 to increase the rotation angle, meeting the needs of users and further improving practicality of the folding stand 1.

For example, as shown in FIG. 2, a first surface of the lower shell component 12 (e.g., the back side of the lower shell component 12 mentioned above) includes a first groove 121 provided at an end where the lower shell component 12 is connected to the upper shell component 11. The supporting slide plate 13 and the transmission component 14 are both provided in the first groove 121.

The first groove 121 is configured to limit movement of the supporting slide plate 13 along a direction perpendicular to the surface of the lower shell component 12. In an example, a limiting groove may be provided on a side wall of the first groove 121, and an extension direction of the limiting groove may be parallel to a first direction X. The first direction X is perpendicular to a direction of a connecting shaft between the lower shell component 12 and the upper shell component 11, and is parallel to the first surface of the lower shell component 12. Furthermore, the supporting slide plate 13 may be provided in the limiting groove that limits the supporting slide plate 13, so that the supporting slide plate 13 can only move along the first direction X away from the second end of the lower shell component 12, or move along an opposite direction of the first direction X close to the second end of the lower shell component 12, but cannot move along a direction perpendicular to the surface of the lower shell component 12, thereby limiting the supporting slide plate 13 to prevent the supporting slide plate 13 from falling off the lower shell component 12, and improving the stability of the folding stand 1.

Specifically, while the upper shell component 11 is rotated relative to the lower shell component 12 to increase the angle between the upper shell component 11 and the lower shell component 12, the supporting slide plate 13 slides relative to the lower shell component 12 along the first direction X to move away from the second end of the lower shell component 12, and at least part of the supporting slide plate 13 slides out of the first groove 121, as shown in FIG. 2, and thus can support the upper shell component 11, thereby increasing a supporting area of the folding stand 1 for the upper shell component 11. The supporting area at this time is the area of the lower shell component 12 plus the area of the supporting slide plate 13, avoiding overturning due to an excessive angle between the upper shell component 11 and the lower shell component 12, improving the stability of the folding stand 1 for placing the mobile device 2, and improving user experience of the folding stand 1.

In an example, since the transmission component 14 and the supporting slide plate 13 are both provided in the first groove 121, that is, the transmission component 14 or the supporting slide plate 13 do not protrude from the first surface of the lower shell component 12, flatness of the first surface of the lower shell component 12 is ensured. When the first surface of the lower shell component 12 is placed on a horizontal desktop, the entire area of the first surface may be placed on the desktop, thereby ensuring the stability of the folding stand 1 when placed on the desktop.

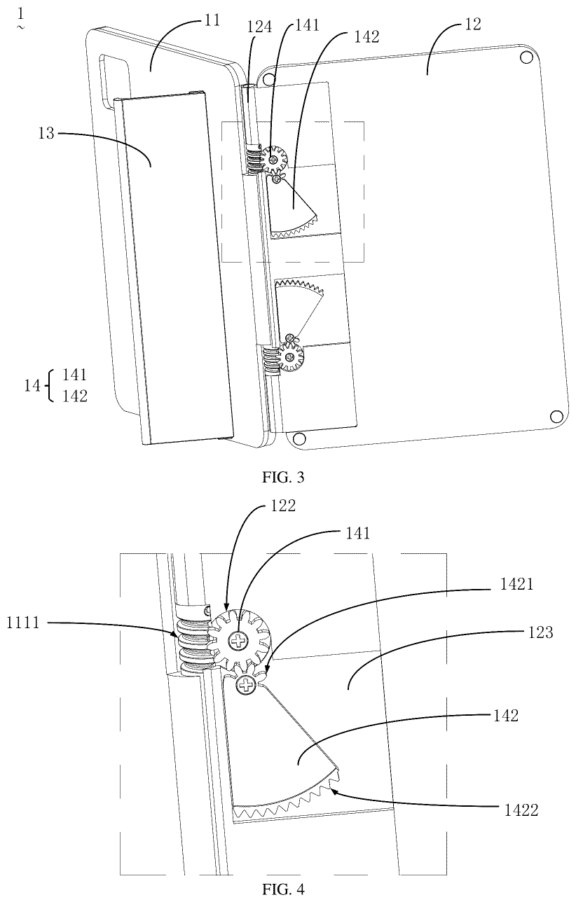

FIG. 3 is a schematic structural diagram of a folding stand according to a third example of the present disclosure; FIG. 4 is a schematic diagram of a partial structure of the folding stand shown in FIG. 3. The transmission component 14 may include a gear 141 and a swing block 142.

The gear 141 and the swing block 142 are both provided in the first groove 121, and gear teeth of the gear 141 abut against first gear teeth 1421 of the swing block 142 to drive the swing block 142 to swing. The first gear teeth 1421 is provided at a first end of the swing block 142, and a second end of the swing block 142 abuts against the supporting slide plate 13. The swing block 142 drives the supporting slide plate 13 to slide through the second end of the swing block 142. The first end and the second end of the swing block 142 are opposite ends of the swing block 142.

As shown in FIG. 3, the swing block 142 may be provided at the bottom of the first groove 121 by a detachable component such as a screw, and the screw is fixed to the first end of the swing block 142. When the gear 141 is rotated, the gear teeth of the gear 141 engage with the first gear teeth 1421 to drive the swing block 142 to swing with the screw as a center, and then the second end of the swing block 142 drives the supporting slide plate 13 to slide relative to the lower shell component 12.

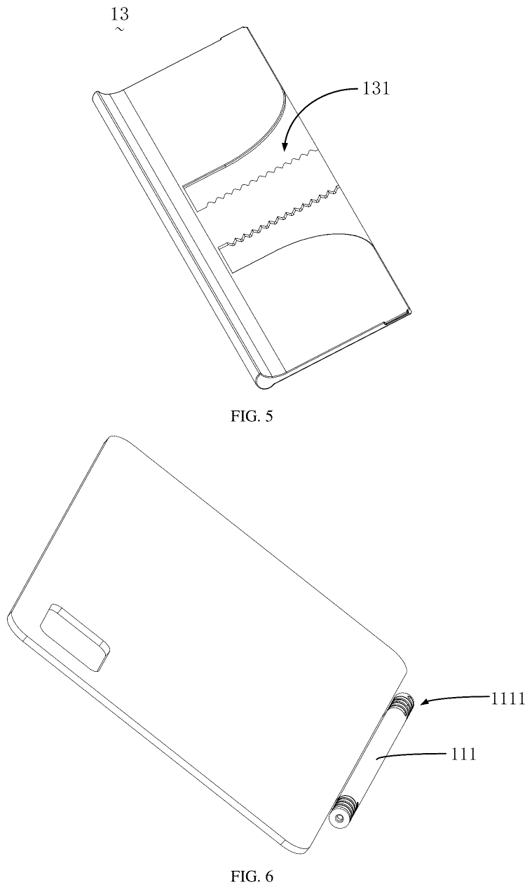

For example, the second end of the swing block 142 includes second gear teeth 1422, as shown in FIG. 5, which is a schematic structural diagram of a supporting slide plate according to an example of the present disclosure. A side of the supporting slide plate 13 close to the swing block 142 includes third gear teeth 131, the third gear teeth 131 abut against the second gear teeth 1422, and the swing block 142 drives the supporting slide plate 13 to slide through the engagement of the second gear teeth 1422 and the third gear teeth 131.

The second gear teeth 1422 of the swing block 142 abut against the third gear teeth 131 of the supporting slide plate 13, and when the gear 141 drives the swing block 142 to swing, the second gear teeth 1422 engage with the third gear teeth 131, and then the swing block 142 drives the supporting slide plate 13 to slide relative to the lower shell component 12.

In an example, taking the viewing angle shown in FIG. 3 as an example, when the upper shell component 11 is rotated relative to the lower shell component 12 to increase the angle between the upper shell component 11 and the lower shell component 12, the swing block 142 swings clockwise to drive the supporting slide plate 13 to move away from the second end of the lower shell component 12 along the first direction X, thereby increasing the supporting area for the upper shell component 11. When the upper shell component 11 is rotated relative to the lower shell component 12 to reduce the angle between the upper shell component 11 and the lower shell component 12, the swing block 142 swings counterclockwise to drive the supporting slide plate 13 to approach the second end of the lower shell component 12 in an opposite direction of the first direction X, and the supporting slide plate 13 returns into the first groove 121. When the angle between the upper shell component 11 and the lower shell component 12 decreases, the support force of the lower shell component 12 is sufficient, and there is no need for the supporting slide plate 13 to provide additional support, the supporting slide plate 13 returns into the first groove 121, thereby ensuring aesthetic of the folding stand 1 and reducing the occupied area of the folding stand 1.

For example, an angle between any two adjacent gear teeth on the gear 141 is greater than an angle between any two adjacent gear teeth in the first gear teeth 1421.

Therefore, a rotation speed of the gear 141 is greater than a swing speed of the first gear teeth 1421. When the gear 141 drives the swing block 142 to swing, since the angle between any two adjacent gear teeth on the gear 141 is greater than the angle between any two adjacent gear teeth in the first gear teeth 1421, when the gear 141 is rotated, the swing block 142 swings at a speed less than the rotation speed of the gear 141, thereby preventing the swing block 142 from driving the supporting slide plate 13 to slide too fast, thereby improving smoothness of the sliding of the supporting slide plate 13.

In an example, the user may set a ratio of the angle between any two adjacent gear teeth on the gear 141 to the angle between any two adjacent gear teeth in the first gear teeth 1421 as needed, and then associate a change speed of the angle at which the upper shell component 11 is rotated relative to the lower shell component 12 with the sliding speed of the supporting slide plate 13, thereby improving the convenience of the folding stand 1.

For example, continuing to refer to FIG. 4, the first surface of the lower shell component 12 further includes a second groove 122 and a third groove 123 both provided at the bottom of the first groove 121. The second groove 122 and the third groove 123 may be connected to each other.

The gear 141 is provided in the second groove 122, and the swing block 142 is provided in the third groove 123. The second groove 122 is a circular groove, and a size of the second groove 122 is greater than or equal to a size of the gear 141. Thus, the gear 141 is placed in the second groove 122, and the second groove 122 can limit the gear 141.

For example, referring to FIGS. 3, 4 and 6, FIG. 6 is a schematic structural diagram of an upper shell component according to an example of the present disclosure. The upper shell component 11 includes a rotating rod 111, and the lower shell component 12 includes a fixing member 124. The upper shell component 11 and the lower shell component 12 are rotatably connected through joining of the rotating rod 111 and the fixing member 124 (e.g., based on connection of the rotating rod 111 and the fixing member 124). For example, the upper shell component 11 and the lower shell component 12 are rotated with a central axis of the rotating rod 111 as a rotating axis.

The rotating rod 111 is provided with a guide groove 1111 extending on the body of the rotating rod 111 in a direction away from an end surface of the rotating rod 111. The second groove 122 is spaced apart from the rotating rod 111, and part of the gear teeth of the gear 141 in the second groove 122 are provided in the guide groove 1111.

Specifically, when the rotating rod 111 is rotated to cause the rotation of the upper shell component 11 relative to the lower shell component 12, since part of the gear teeth of the gear 141 are provided in the guide groove 1111, the guide groove 1111 drives the gear 141 to rotate, then the gear 141 drives the swing block 142 to swing, and the swing block 142 drives the supporting slide plate 13 to slide.

In this example, the guide groove 1111 on the rotating rod 111 drives the gear 141 to rotate, so that when the upper shell component 11 is rotated relative to the lower shell component 12, the supporting slide plate 13 slides based on the angle between the upper shell component 11 and the lower shell component 12.

Specifically, when the upper shell component 11 is rotated relative to the lower shell component 12 to increase the angle between the upper shell component 11 and the lower shell component 12, the rotating rod 111 can be rotated clockwise. The guide groove 1111 on the rotating rod 111 drives the gear 141 to rotate, and then the gear 141 drives the supporting slide plate 13 to slide away from the second end of the lower shell component 12 through the swing block 142, thereby increasing the supporting area for the upper shell component 11. Because the rotation of the gear 141 is driven by the guide groove 1111 and the guide groove 1111 is driven to rotate by the rotation of the rotating rod 111, while the upper shell component 11 is rotated relative to the lower shell component 12 to increase the angle between the upper shell component 11 and the lower shell component 12, the supporting slide plate 13 gradually slides away from the second end of the lower shell component 12 as the angle between the upper shell component 11 and the lower shell component 12 increases, thereby ensuring that the supporting slide plate 13 follows the rotation of the upper shell component 11.

While the upper shell component 11 is rotated relative to the lower shell component 12 to reduce the angle between the upper shell component 11 and the lower shell component 12, the rotating rod 111 can be rotated counterclockwise to drive the gear 141 to rotate clockwise, then the swing block 142 swings counterclockwise, and the supporting slide plate 13 slides close to the lower shell component 12. When the angle between the upper shell component 11 and the lower shell component 12 decreases, the supporting slide plate 13 gradually slides back into the first groove 121 to ensure the aesthetic of the folding stand 1.

In an example, as shown in FIGS. 3 and 4, the first surface of the lower shell component 12 includes two gear grooves, each of which includes the communicating second groove 122 and third groove 123. The two gear grooves are provided at the bottom of the first groove 121 and symmetrically in the first groove 121.

The folding stand 1 includes two transmission components 14 respectively provided in the gear grooves to drive the supporting slide plate 13 to slide, thereby improving smoothness of the sliding of the supporting slide plate 13 and improving the practicality of the folding stand 1.

In an example, referring to FIGS. 1 and 5, when the supporting slide plate 13 is away from the lower shell component 12, thickness of a first end of the supporting slide plate 13 is less than thickness of a second end of the supporting slide plate 13. The first end of the supporting slide plate 13 is provided close to the second end of the lower shell component 12, and the second end of the supporting slide plate 13 is provided away from the second end of the lower shell component 12.

Partially increasing the thickness of the supporting slide plate 13 can increase strength of the supporting slide plate 13. For example, only the thickness of the supporting slide plate 13 at the end away from the lower shell component 12 is increased to prevent the end with larger thickness from entering the first groove 121 and affecting the stability when the lower shell component 12 is placed on the desktop. Besides, when the supporting slide plate 13 returns to the first groove 121, the thicker end of the supporting slide plate 13 is spaced apart from the rotating rod 111, which can cover the rotating rod 111 and improve the aesthetic of the folding stand 1.

The folding stand 1 of the present disclosure can be applied to the mobile device 2 to change the angle at which the mobile device 2 is placed, and includes the upper shell component 11, the lower shell component 12, the supporting slide plate 13 and the transmission component 14. The upper shell component 11 is configured to place the mobile device 2, and the lower shell component 12 is rotatably connected to the upper shell component 11. The upper shell component 11 is rotated relative to the lower shell component 12 to change the angle at which the mobile device 2 is placed, and the lower shell component 12 is configured to support the upper shell component 11. The supporting slide plate 13 and the transmission component 14 are both provided on the lower shell component 12 and close to the connection between the upper shell component 11 and the lower shell component 12, and the transmission component 14 abuts against the supporting slide plate 13. While the upper shell component 11 is rotated relative to the lower shell component 12 to increase an angle between the upper shell component 11 and the lower shell component 12, the transmission component 14 moves to drive the supporting slide plate 13 to slide relative to the lower shell component 12 in a direction away from a second end of the lower shell component 12, so as to increase a supporting area for the upper shell component 11 and increase stability of supporting the upper shell component 11. This avoids the situation that the folding stand 1 and the mobile device 2 overturn due to the insufficient support force of the lower shell component 12 on the upper shell component 11 when the angle between the upper shell component 11 and the lower shell component 12 is large, thereby improving the stability and practicality of the folding stand 1 and improving the user experience of the folding stand 1.

Besides, the transmission component 14 includes the gear 141 and the swing block 142. The upper shell component 11 is rotatably connected to the lower shell component 12 through the rotating rod 111, the rotating rod 111 is provided with the guide groove 1111, and part of the gear teeth of the gear 141 are provided in the guide groove 1111. When the upper shell component 11 is rotated relative to the lower shell component 12, the guide groove 1111 drives the gear 141 to rotate, and the gear 141 drives the supporting slide plate 13 to slide through the swing block 142, so that the supporting slide plate 13 slides as the angle between the upper shell component 11 and the lower shell component 12 changes, thereby improving the practicality of the folding stand 1.

The present disclosure further provides a system such as a folding assembly, including the folding stand 1 and the mobile device 2, in which the mobile device 2 is provided on the upper shell component 11 of the folding stand 1, and the upper shell component 11 is rotated relative to the lower shell component 12 of the folding stand 1 to change the angle at which the mobile device 2 is placed. The mobile device 2 may be placed on the upper shell component 11 by, for example, magnetic attraction.

While the upper shell component 11 is rotated relative to the lower shell component 12, the supporting slide plate 13 of the folding stand 1 slides relative to the lower shell component 12, so as to change the supporting area for the mobile device 2 and improve the placement stability of the folding device.

In an example, when the upper shell component 11 is rotated relative to the lower shell component 12 so that the angle between the upper shell component 11 and the lower shell component 12 increases, and the supporting slide plate 13 slides relative to the lower shell component 12 away from the second end of the lower shell component 12, so as to increase the supporting area for the mobile device 2 and improve the placement stability of the folding device.

In another example, when the upper shell component 11 is rotated relative to the lower shell component 12 so that the angle between the upper shell component 11 and the lower shell component 12 decreases, and the supporting slide plate 13 slides relative to the lower shell component 12 close to the second end of the lower shell component 12 and returns into the first groove 121, thereby improving the aesthetic of the folding device.

The above are only preferred examples of the present disclosure and do not limit the scope of the disclosure. Transformation of an equivalent structure or process made with the contents of the description and drawings of the present disclosure is directly or indirectly used in other related technical fields, and should be included in the protection scope of the present disclosure.

What is claimed is:

1. A foldable stand comprising:
a first plate configured to support a mobile device;
a second plate rotatably connected to the first plate, wherein the second plate is configured to support the first plate;
a supporting plate coupled to the second plate; and
a transmission device on the second plate, wherein the transmission device is configured to abut against the supporting plate,
wherein in response to rotation of the first plate relative to the second plate, the transmission device is configured to drive the supporting plate to slide relative to the second plate.

2. The foldable stand of claim 1, wherein:
a first surface of the second plate comprises a first groove at an end of the second plate where the second plate is connected to the first plate,
the supporting plate and the transmission device are both provided in the first groove, and
the first groove is configured to limit movement of the supporting plate along a direction perpendicular to the surface of the second plate.

3. The foldable stand of claim 2, wherein:
in response to the rotation of the first plate relative to the second plate, at least part of the supporting plate is configured to extend out of the first groove to support the first plate.

4. The foldable stand of claim 2, wherein:
the transmission device comprises a gear and a swing block in the first groove, and gear teeth of the gear are configured to abut against first gear teeth of the swing block to drive the swing block to swing, the first gear teeth being provided at a first end of the swing block,
a second end of the swing block is configured to abut against the supporting plate, the second end of the swing block being opposite to the first end of the swing block, and
the swing block is configured to drive the supporting plate to slide through the second end of the swing block.

5. The foldable stand of claim 4, wherein:
the second end of the swing block comprises second gear teeth,
a side of the supporting plate close to the swing block comprises third gear teeth, and
the third gear teeth are configured to abut against the second gear teeth, and the swing block is configured to drive the supporting plate to slide based on engagement of the second gear teeth and the third gear teeth.

6. The foldable stand of claim 4, wherein an angle between two adjacent gear teeth on the gear is greater than an angle between two adjacent gear teeth in the first gear teeth.

7. The foldable stand of claim 4, wherein:
the first surface of the second plate further comprises a second groove and a third groove both provided at the bottom of the first groove,
the gear is provided in the second groove, and the swing block is provided in the third groove, and
the second groove is a circular groove, and a size of the second groove is greater than or equal to a size of the gear.

8. The foldable stand of claim 7, wherein:
the first plate comprises a rotating rod, and the second plate comprises a fixing member,
the first plate and the second plate are rotatably connected based on connection of the rotating rod and the fixing member,
the rotating rod is provided with a guide groove extending on a body of the rotating rod,
the second groove is spaced apart from the rotating rod, and part of the gear teeth of the gear in the second groove are provided in the guide groove, and
the rotation of the first plate relative to the second plate is based on rotation of thee rotating rod.

9. The foldable stand of claim 7, wherein:
the first surface of the second plate comprises two gear grooves,
the transmission device is in one of the two gear grooves, and
the foldable stand comprises a second transmission device in another one the two gear grooves.

10. The foldable stand of claim 1, wherein a thickness of a first end of the supporting plate is less than thickness of a second end of the supporting plate, the first end of the supporting plate is closer to the second end of the second plate than the second end of the supporting plate.

11. A system comprising:
a mobile device; and
a foldable stand comprising:
a first plate configured to support the mobile device;
a second plate rotatably connected to the first plate, wherein the second plate is configured to support the first plate;
a supporting plate coupled to the second plate; and
a transmission device on the second plate, wherein the transmission device is configured to abut against the supporting plate,
wherein in response to rotation of the first plate relative to the second plate, the transmission device is configured to drive the supporting plate to slide relative to the second plate.

12. The system of claim 11, wherein:
a first surface of the second plate comprises a first groove at an end of the second plate where the second plate is connected to the first plate,
the supporting plate and the transmission device are both provided in the first groove, and
the first groove is configured to limit movement of the supporting plate along a direction perpendicular to the surface of the second plate.

13. The system of claim 12, wherein:
in response to the rotation of the first plate relative to the second plate, at least part of the supporting plate is configured to extend out of the first groove to support the first plate.

14. The system of claim 12, wherein:
the transmission device comprises a gear and a swing block in the first groove, and gear teeth of the gear are configured to abut against first gear teeth of the swing block to drive the swing block to swing, the first gear teeth being provided at a first end of the swing block,
a second end of the swing block is configured to abut against the supporting plate, the second end of the swing block being opposite to the first end of the swing block, and
the swing block is configured to drive the supporting plate to slide through the second end of the swing block.

15. The system of claim 14, wherein:
the second end of the swing block comprises second gear teeth,
a side of the supporting plate close to the swing block comprises third gear teeth, and
the third gear teeth are configured to abut against the second gear teeth, and the swing block is configured to drive the supporting plate to slide based on engagement of the second gear teeth and the third gear teeth.

16. The system of claim 14, wherein an angle between two adjacent gear teeth on the gear is greater than an angle between two adjacent gear teeth in the first gear teeth.

17. The system of claim 14, wherein:
the first surface of the second plate further comprises a second groove and a third groove both provided at the bottom of the first groove,
the gear is provided in the second groove, and the swing block is provided in the third groove, and
the second groove is a circular groove, and a size of the second groove is greater than or equal to a size of the gear.

18. The system of claim 17, wherein:
the first plate comprises a rotating rod, and the second plate comprises a fixing member,
the first plate and the second plate are rotatably connected based on connection of the rotating rod and the fixing member,
the rotating rod is provided with a guide groove extending on a body of the rotating rod,
the second groove is spaced apart from the rotating rod, and part of the gear teeth of the gear in the second groove are provided in the guide groove, and
the rotation of the first plate relative to the second plate is based on rotation of thee rotating rod.

19. The system of claim 17, wherein:
the first surface of the second plate comprises two gear grooves,
the transmission device is in one of the two gear grooves, and
the foldable stand comprises a second transmission device in another one the two gear grooves.

20. The system of claim 11, wherein a thickness of a first end of the supporting plate is less than thickness of a second end of the supporting plate, the first end of the supporting plate is closer to the second end of the second plate than the second end of the supporting plate.
